(19) United States
(12) Patent Application Publication
(10) Pub. No.: US 2015/0322693 A1
(43) Pub. Date: Nov. 12, 2015

(54) LUGGAGE LOCK WITH IDENTIFICATION AND LOCATION TRACKING

(71) Applicant: IAN LEVINE, ORLANDO, FL (US)

(72) Inventor: IAN LEVINE, ORLANDO, FL (US)

(21) Appl. No.: 14/273,792

(22) Filed: May 9, 2014

(51) Int. Cl. E05B 47/00; H04W 4/00

(52) U.S. Cl. CPC E05B 47/00; H04W 4/008

(57) ABSTRACT

A luggage lock with identification and location tracking includes a hardened main body having a shackle, at least one lock engagement unit, a speaker one or more lights, a processor, memory, a communication unit, and a GPS location module.

### TECHNICAL FIELD

The present invention relates generally to Luggage identification and tracking systems, and more particularly to a luggage lock which can assist a user in identifying and locating a piece of luggage to which the lock is attached.

### BACKGROUND

The statements in this section merely provide background information related to the present disclosure and may not constitute prior art.

When traveling on mass transit systems such as airliners and/or cruise ships, for example, finding and identifying individual pieces of luggage can be time consuming and difficult. For example, it is common for airports to place luggage onto a revolving luggage carousel, from which hundreds of commuters must simultaneously sort through a staggering assortment of similarly shaped and colored pieces of luggage. This inconvenience increases in proportion to the number of commuters and luggage pieces being retrieved. Specifically, it becomes increasing more difficult to get into position to retrieve luggage and correctly determine which is your luggage. This problem is exaggerated by the fact that a commuter has only a very short time to identify and retrieve his luggage before it passes out of reach. In the event the luggage escapes, the commuter is often forced to wait until the luggage completes its journey around the carousel to make another attempt.

In addition to the above, it is not uncommon for an airline to temporarily or permanently lose individual pieces of luggage during transit. In these situations, the traveler is at the mercy of the airline to find their luggage and deliver it to the user's location. Unfortunately, due to the large volume of luggage transported by airlines, this process can take anywhere from a few hours to a few weeks.

Finally, in addition to the problems associated with identifying and locating luggage, some travelers receive their bags only to discover that during transit their bags were opened and some of their valuables have been stolen.

Although there are known devices which attempt to address portions of the above noted problems individually, none of these methodologies disclose a luggage lock with identification and location tracking that performs the functions described herein.

### SUMMARY OF THE INVENTION

The present invention is directed to a luggage lock with identification and location tracking. One embodiment of the present invention can include a hardened lock body having a shackle and at least one lock engagement units such as a dial or key cylinder. The shackle can engage a piece of luggage in order to prevent the contents of the luggage from being stolen.

Another embodiment of the present invention can include an identification unit having a processor, a speaker, a plurality of lights and a communication unit which can send and receive information wirelessly with an external device such as a smartphone or remote control, for example. The identification unit can function to allow a user to selectively activate the speaker and/or lights in order to quickly find their luggage.

Yet another embodiment of the present invention can include a GPS location module which can function to allow a user to track the location of the lock, and the corresponding luggage using a commercially available tracking software.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal view of a luggage lock with identification and location tracking, in accordance with one embodiment of the invention.

FIG. 2 is a simplistic block circuit diagram of a luggage lock with identification and location tracking, in accordance with one embodiment of the invention.

FIG. 3 is a frontal view of a luggage lock with identification and location tracking, in accordance with another embodiment of the invention.

FIG. 4 is a frontal view of the luggage lock with identification and location tracking in operation, and in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

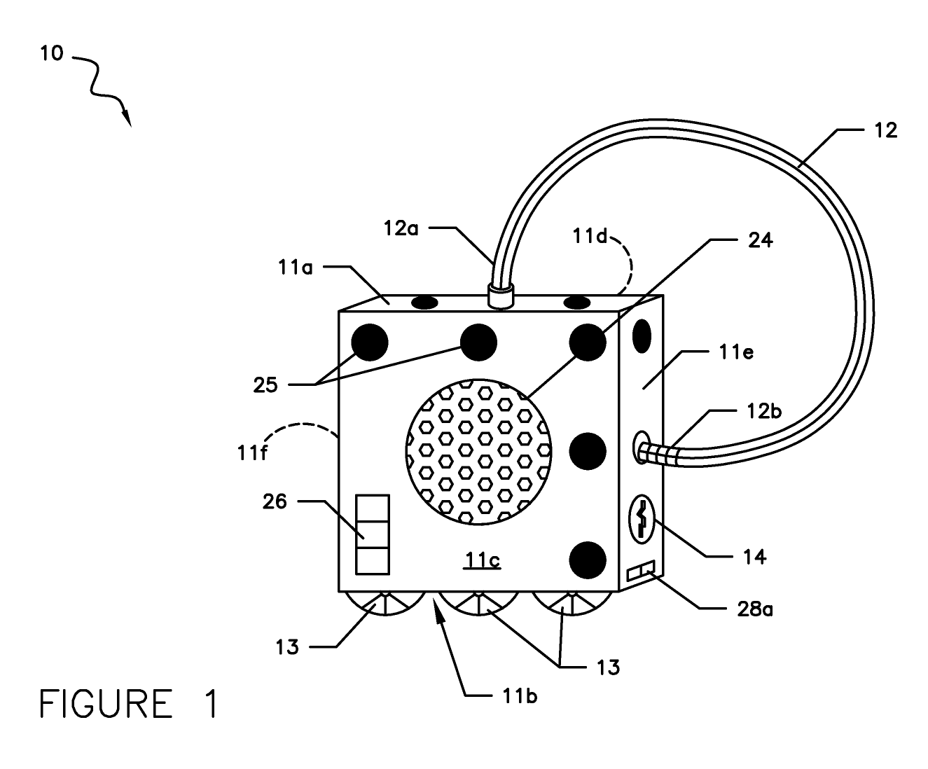

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1. As described herein, the term “removably secured” shall be used to describe a situation wherein two or more objects are joined together in a non-permanent manner so as to allow the same objects to be repeatedly joined and separated.

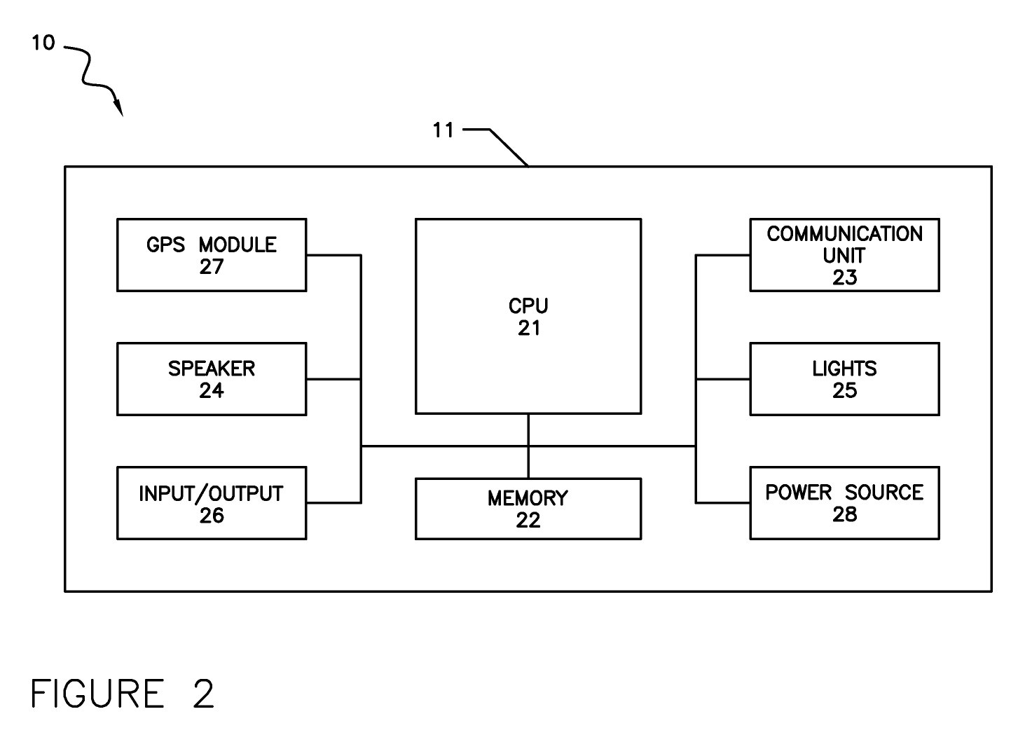

FIGS. 1 and 2 illustrate one embodiment of a luggage lock with identification and location tracking 10 that is useful for understanding the inventive concepts disclosed herein. As will be described throughout this document, the lock 10 can function to prevent luggage from being accessed by unauthorized individuals, and can assist a user in identifying the location of the luggage itself.

As shown, the lock 10 can include a main body 11 having a top end 11a, a bottom end 11b, a front surface 11c, a back surface 11d and a pair of opposing side surfaces 11e and 11f, forming a generally rectangular member defining an interior space. The lock can further include a shackle 12 having a first end 12a and a second end 12b that is coupled to main body, and engageable via a locking mechanism located within the interior space. In this regard, the locking mechanism can be communicatively linked to both the shackle and one or more lock engagement units, such as the combination dials 13 that are also located on the main body, and a Transportation Security Administration (TSA) approved/mandated key cylinder 14. In either instance, the lock engagement unit can function to transition the locking mechanism/shackle between a locked state wherein the second end of the shackle 12b is secured to the main body, and an unlocked state, wherein the second end of the shackle 12b is not secured to the main body.

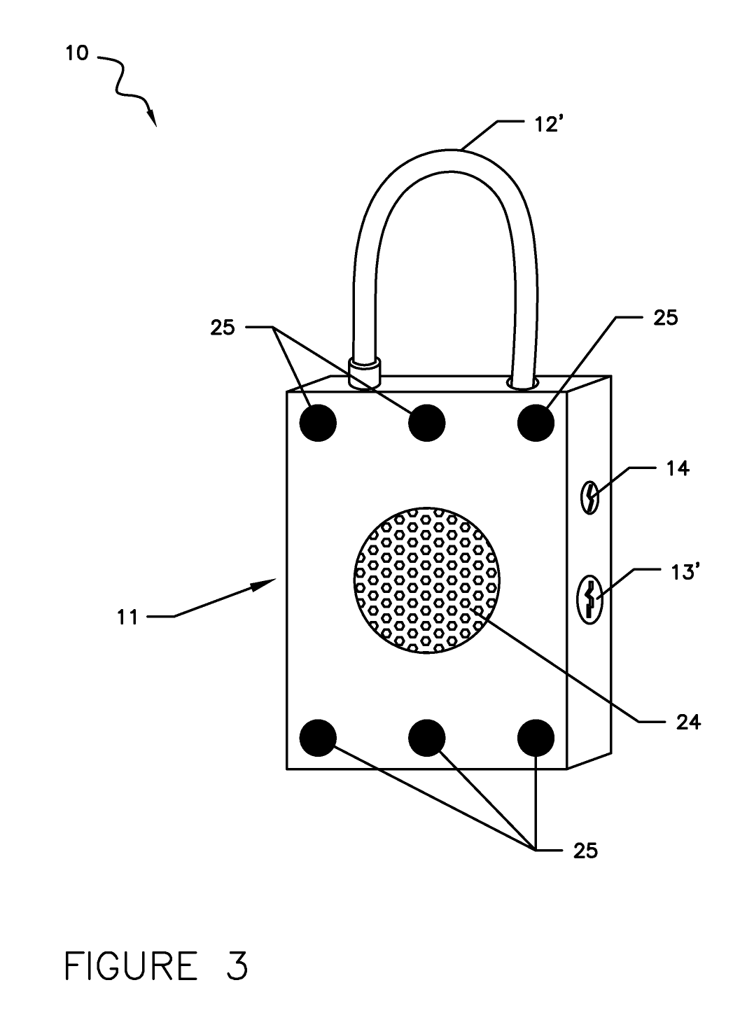

In the preferred embodiment, the main body 11 can be constructed from any number of hardened, sturdy and durable materials such as steel or zinc, for example that impact and cut resistant, while remaining relatively lightweight. Of course, any number of other suitable materials such as various metals, high strength polymers and/or composite material can also be utilized herein. Although described above as including a generally rectangular shape, this is for illustrative purposes only, as the main body can take any number of different shapes, sizes and dimensions suitable for use with a variety of luggage components. Additionally, the lock is not limited to using combination dials 13, as any number of other lock engagement members can be utilized. Several nonlimiting examples including the input/output unit 26, keypads, one or more physical keys 13′ (See FIG. 3) and the like are also contemplated.

In one embodiment, the first end of the shackle 12a can be permanently joined to the top side of the main body 11a, and the second end 12b can be removably joined to the side of the main body 11e. Although not illustrated, the internal locking mechanism can engage and secure the second end of the shackle 12b against the main body, until the locking mechanism is unlocked via the combination dial(s) and/or the TSA lock 14. The internal components of locking mechanisms and associated key locks and/or combination dials are well known in the art, therefore no further description will be provided herein.

In the preferred embodiment, the shackle 12 can be constructed from an elongated flexible braided steel cable having a polymer sleeve covering the length thereof. However, other embodiments wherein the shackles are joined to different portions of the main body are also contemplated, and although described above as including a flexible shackle, any number of other suitable shackle materials can also be utilized herein. For example, the shackle can also include a rigid U-shaped shackle 12′ (See FIG. 3), or rigid shackles of varying shapes.

As shown best in FIG. 2, the lock can also include a processor 21 that is conventionally connected to an internal memory 22, a communication unit 23, a speaker 24, one or more lights 25, an input/output unit 26, a GPS location module 27 and a power source 28.

The processor/CPU 21 can act to execute program code stored in the memory 22 in order to allow the device to perform the functionality described herein. Processors are extremely well known in the art, therefore no further description will be provided.

Memory 22 can act to store operating instructions in the form of program code for the processor 21 to execute. Although illustrated in FIG. 2 as a single component, memory 22 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 22 can also include one or more cache memories that provide temporary storage of at least some program code in order to reduce the number of times program code must be retrieved from the bulk storage device during execution. Each of these devices are well known in the art.

The communication unit 23 can include any number of devices capable of communicating with an external device either directly or over a network. In one preferred embodiment, the communication unit can include Bluetooth transceiver for communicating wirelessly with an application located on a mobile telephone. However, any number of other known transmission and reception mechanisms and protocols can also be utilized herein, several nonlimiting examples include unique radio frequencies, infrared (IR), RFID, and/or a network adapter functioning to communicate over a WAN, LAN or the internet via an internet service provided.

The speaker 24 can function in a conventional manner to play an audible sound such as an alarm tone or a pre-recorded message upon being activated by the processor. Each of the one or more lights 25 can preferably include a light emitting diode (LED), for example, that are disposed along various surfaces of the main body 11. Each of the lights 25 can include any number of different colors, and can function to flash, or remain illuminated, based on an instruction from the processor.

One or more input/output units, such as the buttons 26 can act to accept user inputs and provide instructions to the processor. In one preferred embodiment, each of the buttons can be connected to the processor 21 so as to activate different programmatic functions. For example, the buttons 26 can function to switch the electronic components of the lock between an ON and OFF state, initiate a Sleep mode, pair the Bluetooth transceiver with an approved user device, and so on. In another embodiment, the buttons 26 can also engage the locking mechanism in order to transition the lock between a locked state and an unlocked state.

In one embodiment, the lock can further include GPS location module 27 which can be used to locate the device/luggage in the event that the luggage becomes lost or separated from the user. In the preferred embodiment, the GPS locator module can include a GPS signal antenna, and an independent transceiver for communicating with a third party location tracking company that provides tracking and retrieval services for registered GPS enabled devices. One example of a GPS location module and associated system for tracking the same can be found in U.S. Pat. No. 6,243,039, to Elliot, the contents of which are incorporated herein by reference.

In one preferred embodiment, the power source 28 can include one or more DC batteries capable of providing the necessary power requirements to each element of the luggage lock 10. In one embodiment, the batteries can be integrated into the device and can be rechargeable in nature via a charging port 28a, such as a mini or micro USB port, for example. Such a feature can prevent an unauthorized user from removing the batteries in an attempt to defeat the alarm. Of course, traditional batteries can also be utilized and the main body 11 can further include a battery compartment having a removable cover (not illustrated) for allowing a user to access the same.

Although illustrated above as including individual circuit elements, those of skill in the art will recognize that one or more system components may be, or include one or more printed circuit boards (PCB) containing an integrated circuit or circuits for completing the activities described herein. The CPU may be one or more integrated circuits having firmware for causing the circuitry to complete the activities described herein.

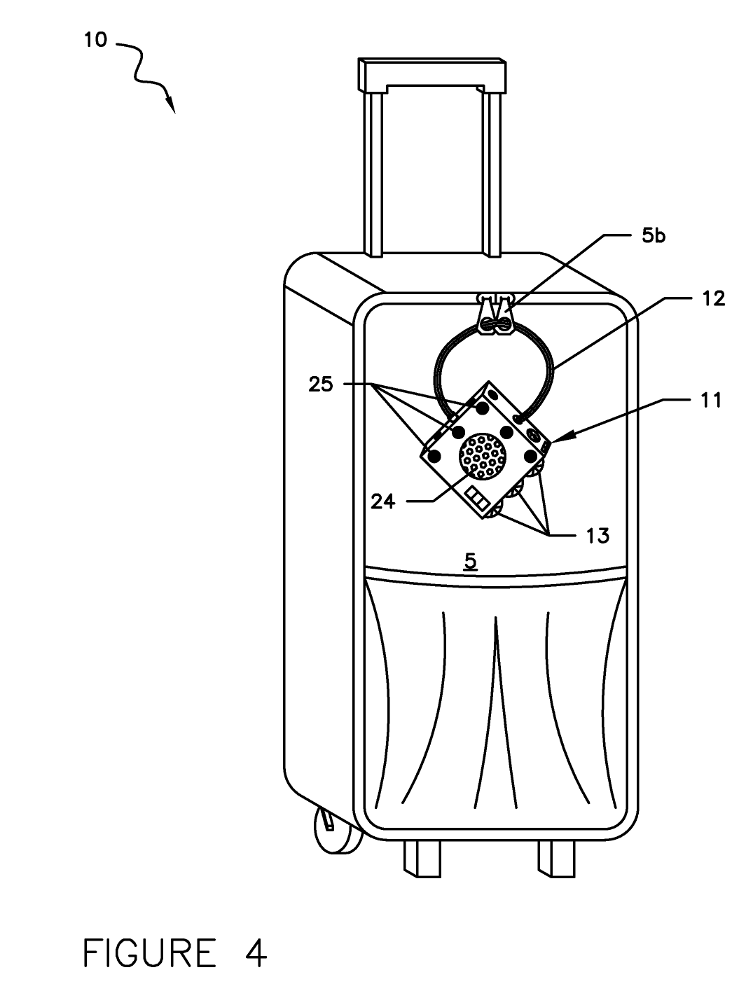

FIG. 4 illustrates one embodiment of the device in operation. As shown, the lock 10 may be secured to a piece of luggage 5 in a manner that can prevent the bag from being opened. For example, the shackle 12 can be routed through the pull tab 5a of a zipper slider and/or around other structures of the luggage such as a clasp or luggage handle. Once secured thereon, the shackle can reengage the internal locking mechanism, and the lock can remain secured to the bag until retrieved by the luggage owner.

In addition to the above, the lock 10 can function to allow a bag owner to quickly identify their bag in crowded terminal locations or other such venues. For example, and as noted above, the communication unit 23 can include a Bluetooth transceiver 23 which can interface with the processor 21, memory 22 and input/output unit 26 in order to be paired with an external device. In one embodiment, the external device can include a users' smartphone, a remote control, or other such device which can send and receive user commands to the lock 10.

In this regard, once a communication protocol has been established between the lock 10 and a user device, the user can transmit instructions to the lock to selectively activate the speaker 24 and/or lights 25, in order to allow the user to readily identify their bag amongst the other bags in the terminal. As described herein, the speaker 24 can project a pre-recorded message which can be stored within the device memory 22, or can project real time sounds transmitted by the external user device and received by the communication unit 23.

Finally, as noted above, the device can include functionality for tracking the location of lost or stolen luggage via the GPS location module described above.

Accordingly, the above described luggage lock with identification and location tracking can function to assist travelers with protecting and locating their belongings in a novel manner.

As described herein, one or more elements of the luggage lock with identification and location tracking 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements may be formed together as one or more continuous elements, either through manufacturing processes, such as welding, casting, or molding, or through the use of singular pieces of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A luggage lock, comprising:
a hardened main body having a plurality of surfaces defining an interior space;
a shackle having a first end that is fixed to the main body, and a second end that is removably secured to the main body;
at least one lock engagement unit functioning to transition the shackle between a locked state and an unlocked state;
a communication unit that is configured to communicate with an external device;
a speaker configured to produce an audible output;
one or more lights configured to produce a visual output;
a memory that is configured to store operating instructions; and
a processor that is in communication with each of the communication unit, the speaker, the one or more lights, and the memory,
wherein the processor is configured to activate each of the speaker and the one or more lights upon receiving a signal from the communication unit.

2. The lock of claim 1, further comprising:
at least one input/output unit that is in communication with the processor, said input/output unit being configured to convey user instructions to the processor.

3. The lock of claim 1, further comprising:
a GPS location module that is in communication with the processor.

4. The lock of claim 1, wherein the communication unit is configured to communicate using, at least one of a unique radio frequency, infrared, Bluetooth, WAN, LAN, and the internet.

5. The lock of claim 1, wherein the communication unit consists of a Bluetooth transceiver.

6. The lock of claim 1, wherein the shackle is flexible, and is constructed from an elongated flexible braided steel cable.

7. The lock of claim 1, wherein the shackle comprises a rigid, generally U-shaped member.

8. The lock of claim 1, wherein the second end of the shackle is secured to the main body when the shackle is in an unlocked state.

9. The lock of claim 1, wherein the second end of the shackle is not secured to the main body when the shackle is in an unlocked state.

10. The lock of claim 1, wherein the at least one lock engagement unit includes one or more combination dials.

11. The lock of claim 1, wherein the at least one lock engagement unit includes a TSA approved key cylinder.

12. The lock of claim 1, further comprising:
a power source that includes one or more DC batteries.

13. The lock of claim 12, further comprising:
a charging port that is located along the main body and is in communication with the power source.
